(19) United States
(12) Patent Application Publication
(10) Pub. No.: US 2022/0263699 A1
(43) Pub. Date: Aug. 18, 2022

(54) A MODULATOR FOR GENERATING AN ORTHOGONAL FREQUENCY DIVISION MULTIPLEXING, OFDM, SIGNAL

(71) Applicant: SIGNIFY HOLDING B.V., EINDHOVEN (NL)

(72) Inventor: Johan-Paul Marie Gerard LINNARTZ, EINDHOVEN (NL)

(21) Appl. No.: 17/625,809

(22) PCT Filed: Jun. 23, 2020
(86) PCT No.: PCT/EP2020/067438

§ 371 Date: Jan. 10, 2022

(30) Foreign Application Priority Data
Jul. 11, 2019 (EP) 19185625.1

(51) Int. Cl. H04L 27/26

(52) U.S. Cl. CPC H04L 27/2627

(57) ABSTRACT

A modulator for generating an Orthogonal Frequency Division Multiplexing, OFDM, signal, said modulator comprising a subcarrier generator block arranged for generating N/2 consecutive subcarriers based on N/2 input data symbols, a zero padding block arranged for consecutive padding said N/2 subcarriers with N/2 zeros, thereby obtaining N subcarriers, an inverse Fourier Transform generator block arranged for performing an N sized inverse Fourier Transform on said N subcarriers thereby providing N time domain signals at an output, wherein said modulator is arranged to convert said N time domain signals into a time domain OFDM signal, and wherein said modulator further comprises and a block arranged for extracting a real-valued part from an inputted complex-valued time domain signal, which block is connected to said output of said inverse Fourier Transform generator block, such that said converted time domain OFDM signal is a real-valued time domain OFDM signal.

### FIELD OF THE INVENTION

The present disclosure generally relates to the field of communication, in particular wireless communication or communication over a fibre, and, more specifically, to a modulator for generating an Orthogonal Frequency Division Multiplexing, OFDM, signal.

### BACKGROUND OF THE INVENTION

Optical wireless communication, OWC, is a form of optical communication in which unguided visible, for example infrared or ultraviolet, light is used to carry a signal.

Systems that utilize optical wireless communication in the visible frequency band range, i.e. somewhere between 390 nm-750 nm, are commonly referred to as visible light communication, VLC, systems. These types of VLC systems take advantage of Light Emitting Diode's, LED's, which LED's can be pulsed at very high frequencies without any noticeable effect on the lighting output and without any effect perceivable for a user. Alternatively, optical wireless communications may make use of (near) infrared, with a wavelength of 750 nm to 3000 nm.

VLC systems may be used in a wide range of applications, including wireless local area networks, LAN's, wireless personal area networks, PAN's, and vehicular networks among others.

Alternatively, terrestrial point-to-point OWC systems, which are also referred to as the free space optical, FSO, systems, typically operate at the near InfraRed, IR, frequencies, for example 750 nm-1600 nm. These types of systems typically use laser transmitters and offer a cost-effective protocol-transparent link with high data rates up to about 10 Gbit/s per wavelength, and provide a potential solution for the backhaul bottleneck.

A growing interest is noticeable on ultraviolet communication, UVC, which operate within solar-blind UV spectrum, i.e. between 200 nm-280 nm.

It is commonly known that intensity modulation OWC or Intensity Modulation, IM, over fibre is not able to cope with signals with negative values, because intensities are by definition non-negative. This means that non-negative transmission signals are to be generated.

One of the transmission techniques that is used in OWC systems is Orthogonal Frequency Division Multiplexing, OFDM. In telecommunications, OFDM is a method of encoding data on a plurality of carriers, wherein the carriers are orthogonal to each other. An OFDM signals tends to be a complex signal which has both positive as well as negative parts. The above has been recognized in the art, and multiple amendments to the traditional OFDM transmission techniques have been proposed. These amendments are directed to the generation of unipolar OFDM signals. As mentioned above, OWC systems are able to cope with unipolar OFDM signals.

Two popular unipolar OFDM systems are FLIP OFDM and ACO OFDM. Both systems are able to convert NPAM data signals into 2N non-negative transmit samples, where mostly N is a power of 2.

Both FLIP OFDM and ACO OFDM start by creating an OFDM signal in which the second part is exactly a polarity-flipped replica of the first part. FLIP OFDM does this by repeating and polarity-flipping an OFDM block of length N. ACO OFDM does this by using an FFT of length 2N and only allowing signal dimensions that have the required period repetition, i.e. the odd subcarriers.

A feature of ACO OFDM is that the subcarriers are by design continuous at the split between the two halves. So, the cyclic prefix and windowing are only needed at the beginning of the 2N frame, while FLIP OFDM would need cyclic prefixes and windowing at both halves.

One of the downsides of the above is that for any wireless communication system that is to operate with unipolar OFDM signals, a choice is to be made which specific unipolar OFDM system to implement. Similarly, intensity modulated communication over optical fibres need unipolar signals.

### SUMMARY OF THE INVENTION

It would be advantageous to achieve a modulator for generating an Orthogonal Frequency Division Multiplexing, OFDM signal that can de deployed more versatilely, i.e. which is more flexible.

It would further be advantageous to achieve a method for generating an OFDM signal in a more flexible manner, such that it can be deployed in multiple unipolar wireless communication systems.

To better address one or more of these concerns, in a first aspect of the disclosure, there is provided a modulator for generating an Orthogonal Frequency Division Multiplexing, OFDM, signal, said modulator comprising:
a subcarrier generator block arranged for generating N/2 consecutive subcarriers based on N/2 input data symbols,
a zero padding block arranged for consecutive padding said N/2 subcarriers with N/2 zeros, thereby obtaining N subcarriers;
an inverse Fourier Transform generator block arranged for performing an N sized inverse Fourier Transform on said N subcarriers thereby providing N time domain signals at an output;

wherein said modulator is arranged to convert said N time domain signals into a time domain OFDM signal, and wherein said modulator further comprises:
a block arranged for extracting a real-valued part from an inputted complex-valued time domain signal, which block is connected to said output of said inverse Fourier Transform generator block, such that said converted time domain OFDM signal is a real-valued time domain OFDM signal.

In, for example, OFDM for intensity modulation, including DC-offset OFDM but also ACO OFDM and FLIP OFDM, a sequence of N real valued time-samples that carry N/2 consecutive subcarriers are generated based from N/2 complex-valued input data symbols. The remaining N/2 input data signals are generated by utilizing the Hermitian symmetry property. This implies that the symbol for subcarrier n, i.e. Xₙ, equals the complex conjugated symbol for subcarrier N-n, i.e. X_{N-n}^{*}. This ensures that a real-valued signal is obtained after performing the inverse Fourier Transform.

The above described property implies that half of the OFDM subcarriers are sacrificed to generate the real-valued time domain OFDM signal. In fact, N/2 complex input signals, usually QAM, generate N real valued numbers, in an invertible manner, so the number of “dimensions” is equal, before and after the inverse Fourier Transform.

The inventor has found that the above described principle, or mechanism, for creating a real-valued OFDM signal may be superfluous. There may not be a need to actually utilize the Hermitian symmetry property for generating the remaining N/2 consecutive subcarriers. As such, there is no need to assure that Xₙ equals X_{N-n}^{*}.

It was found that the remaining N/2 subcarriers may be generated by padding these with N/2 zeros. The result is that a complex-valued signal is obtained after performing the inverse Fourier Transform. However, a same real-valued signal, possibly except for a fixed multiplication by a factor of 2, may be obtained by ignoring the imaginary-valued part of the obtained complex-valued signal as was the case for the traditional mechanism for creating the real-valued OFDM signal.

The above described principle may be used for the generation of any real-valued OFDM signal, including OFDM over a cable in base bane, as in ASDL or power line, for DC-offset OFDM on an Intensity Modulation fibre or OWC.

As such, a traditional real-valued OFDM modulator for generating a FLIP OFDM signal, or ACO OFDM signal, may also be amended in such a way that zero's are placed on the remaining N/2 subcarriers, instead of the complex conjugated symbols in accordance with the Hermitian symmetry property, and in that, after performing the inverse Fourier Transform, the imaginary-valued part of the signal is ignored. That is, the real-valued part of the complex-valued time domain signal after the inverse Fourier Transform is taken, i.e. isolated.

It is noted that the above described modulator in accordance with the present disclosure may be used in all kinds of wireless communication devices, especially in communication devices that utilize real-valued or even unipolar transmission signals.

The modulator may, for example, be deployed in an optical communication system, wherein the optical communication system operates in accordance with visible light, infrared light, or near ultraviolet light.

Further, the modulator may be deployed in a dedicated access point, wherein the dedicated access point does not need to have a function of providing environmental lighting to a room, or in a user device, such as a smartphone or in an Internet of Things, IoT, device.

It is noted that, in accordance with the present disclosure, a real-valued signal may be extracted from the complex signal in various ways. Examples include, but are not limited to, taking the real part of the complex signal, taking the imaginary part, taking a linear combination of the real and imaginary part, or doing phase rotation and the taking the real part. In particular we include also operations in which the combination of real and imaginary part depends on a sample k. A prime example is a phase rotation that linearly increases with k, which will be explained in more detail here below.

The modulator in accordance with the present disclosure operates using N/2 input data symbols. It is noted that some of these N/2 input data symbols may be set to zero, for example the top 2, 3, 4, 5, or 6, input data symbols, for making a sharp spectral mask and to be able to make an aliasing filter.

In an example, the modulator further comprises:
a Parallel to Serial, P/S, generator block for serializing said N time domain signals at said output into a time domain OFDM signal;

wherein said extraction block is connected to said P/S generator block such that said extraction block takes a real-valued part of said serialized time domain OFDM signal.

It was noted that the extraction block should be placed somewhere behind the inverse Fourier Transform generator block. It may be placed directly behind the inverse Fourier Transform generator block; in which case the extraction block is to operate on N different outputs from the inverse Fourier Transform generator block. The modulator may further serialize the outputs from the inverse Fourier Transform generator block, i.e. the N time domain signals, by using a P/S generator. In that case, the extraction block may also be connected to the output of the P/S generator.

In a further example, the modulator may further comprise:
a phase rotation block, connected in between said inverse Fourier Transform generator block and said extraction block, which phase rotation block is arranged for phase rotating an inputted complex-valued time domain signal thereby providing a phase rotated complex-valued time domain signal.

The phase rotation block may, for example, be arranged to phase rotate an inputted complex-valued time domain signal by:

φe^{jπαk/N}

wherein k indicates a k-th time instant of said OFDM signal, and a is a real-valued constant, preferably α=1, and wherein φ is a constant complex-valued phase, preferably φ=1 or φ=±j. The particular choice for α=1, or 3, etc., may ensure specific properties of continuous phase. Without loss of generality, a fixed φ can be applied without losing any properties as disclosed in the present disclosure.

The present disclosure proposes a versatile modulator which can be used for creating an improved implementation for creating a FLIP OFDM signal. It can also be used advantageously for DC offset OFDM, ACO, or other OFDM variants.

To do so, the modulator generates N/2 subcarriers based on N/2 input data symbols, for example Quadrature Amplitude Modulation, QAM, symbols. These generated, consecutive (in frequency), subcarriers are appended with an additional N/2 zero's, such that in total N subcarriers are generated. The N subcarriers are processed by an N-sized inverse Fourier Transform generator block for performing an N sized inverse Fourier Transform on said N subcarriers. After the inverse Fourier Transform a complex-valued time domain signal is obtained. In accordance with the present disclosure, a block is placed somewhere behind the inverse Fourier Transform generator block for extracting only the real-value part from a complex-valued time domain signal.

Thus, the present disclosure does not require the Hermitian Symmetry on the input signals, which is commonly used to ensure a real-valued signal for OWC.

The above described principle may be used particularly for improving a FLIP OFDM signal and creating an ACO-OFDM signal with lower complexity. In fact, the inventor has found that the presence of an imaginary part at the output of the inverse Fourier Transform in the above described principle has a further advantage that can be used for improving FLIP OFDM.

The inventor has further found that the above described principle may also be used for creating an ACO OFDM signal with lower complexity. It was found that ACO OFDM is similar to FLIP OFDM in that all subcarriers are shifted one frequency grid-point upwards. This is equivalent to multiplying the time domain signal by a complex exponential, that mimics a frequency lift, for example of half a subcarrier (α=1). This is accomplished, in accordance with the present disclosure, with the phase rotation block.

Details with respect to the similarity are provided with respect to the description of the figures.

It is noted that the phase rotation block may be enabled, or disabled, by the modulator. In case the modulator intends to create a FLIP OFDM signal, the phase rotation block may be disabled. In case the modulator intends to create an ACO OFDM signal or an improved variant of FLIP OFDM, the phase rotation block may be enabled.

In a further example, the modulator further comprises:
a subcarrier shifter block arranged for shifting said N subcarriers upwards in frequency by one half subcarrier spacing before performing said N sized inverse Fourier Transform by said inverse Fourier Transform generator block.

As mentioned above, a FLIP OFDM signal has similarities with an ACO OFDM signal. An ACO OFDM signal has subcarriers that are shifted one half subcarrier spacing upwards in frequency compared to a FLIP OFDM signal. Such a processing may be accomplished by multiplying a time domain signal, after the inverse Fourier Transform generation, with a complex exponential, or may be accomplished by shifting the N subcarriers upwards in frequency by one half subcarrier spacing before performing the N sized inverse Fourier Transform.

In a further example, the modulator further comprises:
a copy-and-flip block arranged for copying and flipping said real-valued time domain OFDM signal and appending said copied and flipped real-valued time domain OFDM signal to said real-valued time domain signal thereby obtaining a full real-valued time domain OFDM signal.

In another example, the modulator further comprises:
a Cyclic Prefix, CP, generator block arranged for generating a cyclic prefix to said full real-valued time domain OFDM signal.

In a second aspect of the present disclosure, there is provided a method for generating an Orthogonal Frequency Division Multiplexing, OFDM, signal, wherein said method comprises the steps of:
generating N/2 subcarriers based on N/2 input data symbols;
padding said N/2 subcarriers with N/2 zeros, thereby obtaining N subcarriers;
performing an N sized inverse Fourier Transform on said N subcarriers thereby providing N time domain signals at said output;
converting said N time domain signals into a time domain OFDM signal, and
extracting a real-valued part from an inputted complex-valued time domain signal, which block is connected to said output of said inverse Fourier Transform generator lock, such that said converted time domain OFDM signal is a real-valued time domain OFDM signal.

It is noted that the advantages and definitions as disclosed with respect to the examples of the first aspect of the invention, being the modulator, also correspond to the examples of the second aspect of the invention, being the method for generating an OFDM signal.

In an example, the method further comprises the step of:
serializing said N time domain signals at said output into said time domain OFDM signal.

In a further example, the method further comprises the step of:
phase rotating an inputted complex-valued time domain signal thereby providing a phase rotated complex-valued time domain signal.

In another example, the step of phase rotating step is arranged to phase rotate an inputted complex-valued time domain signal by:

φe^{jπαk/N}

wherein k indicates a k-th time instant of said OFDM signal, and α is a real-valued constant, preferably α=1, and wherein φ is a constant complex-valued phase, preferably φ=1 or φ=±j.

In a further example, the method further comprises the step of:
shifting said N subcarriers upwards in frequency by one half subcarrier spacing before performing said N sized inverse Fourier Transform by said inverse Fourier Transform generator block.

In yet another example, the method further comprises the steps of:
copying and flipping said real-valued time domain OFDM signal, and
appending said copied and flipped real-valued time domain OFDM signal to said real-valued time domain signal thereby obtaining a full real-valued time domain OFDM signal.

In an example, the method further comprises the step of:
generating a cyclic prefix to said real-valued time domain OFDM signal.

In a third aspect, there is provided a computer program product comprising a computer readable medium having instructions stored thereon which, when executed by a modulator, cause said modulator to implement a method in accordance with any of the examples as provided above.

It is noted that the advantages and definitions as disclosed with respect to the examples of the first aspect of the invention, being the modulator, also correspond to the examples of the second aspect of the invention, being the computer program product.

In a fourth aspect, there is provided a real-valued time domain OFDM signal obtained by a method in accordance with any of the examples as provided above.

It is noted that the signal produced by the modulator in accordance with any of the previous examples may be detected with a detector known in the art, for example:
FFT-based detectors for DCO-OFDM. Here, received samples may be fed into a receive FFT, having their complex parts set to zero. This results in N/2 complex-valued symbols at the lower half of the subcarriers, while the upper N/2 half of the FFT output contains a Hermitian-symmetric copy of the lower half;
Flip-OFDM detectors in which the second half of the N real samples may be subtracted from first N real samples, wherein the complex parts are set to zero;
ACO-OFDM in which a 2N-sized FFT is used. Here, the received signal may be seen only on the lower half of the odd subcarriers.

In other words, the presented modulator may create signals that a compliant to signals described formally, e.g. in standard documents, as DCO-OFDM, FLIP-OFDM or ACO-OFDM.

Moreover, it can be used in hybrid DC-biased and unipolar OFDM, such as ADO, HACO OFDM. In fact, these are the addition of two OFDM modulation methods, each of which can be generated by solutions disclosed here. To increase the spectrum efficiency, Asymmetrically clipped DC biased Optical OFDM, ADO-OFDM, transmits ACO-OFDM on the odd subcarriers and adds DCO-OFDM on the even subcarriers. Hybrid ACO-OFDM, HACO-OFDM, simultaneously uses ACO-OFDM on odd subcarriers and PAM-DMT on even subcarriers.

These and other aspects of the invention will be apparent from and elucidated with reference to the embodiment(s) described hereinafter.

### BRIEF DESCRIPTION OF THE DRAWINGS

FIG. 1 shows a block diagram of a FLIP Orthogonal Frequency Division Multiplexing, OFDM, modulator in accordance with the prior art;

FIG. 2 shows a block diagram of a ACO Orthogonal Frequency Division Multiplexing, OFDM, modulator in accordance with the prior art;

FIG. 3 shows a block diagram of a modulator in accordance with the present disclosure;

FIG. 4 shows another block diagram of a modulator in accordance with the present disclosure;

FIG. 5 shows a simplified block diagram of a modulator in accordance with the present disclosure;

FIG. 6 shows an extended block diagram of a modulator in accordance with the present disclosure;

FIG. 7 shows a simplified block diagram of a detector in accordance with the present disclosure;

FIG. 8 shows a simplified block diagram of a Light Fidelity, LiFi, transmitter using a modulator in accordance with the present disclosure.

### DETAILED DESCRIPTION

A detailed description of the drawings and figures are presented. It is noted that a same reference number in different figures indicates a similar component or a same function of various components.

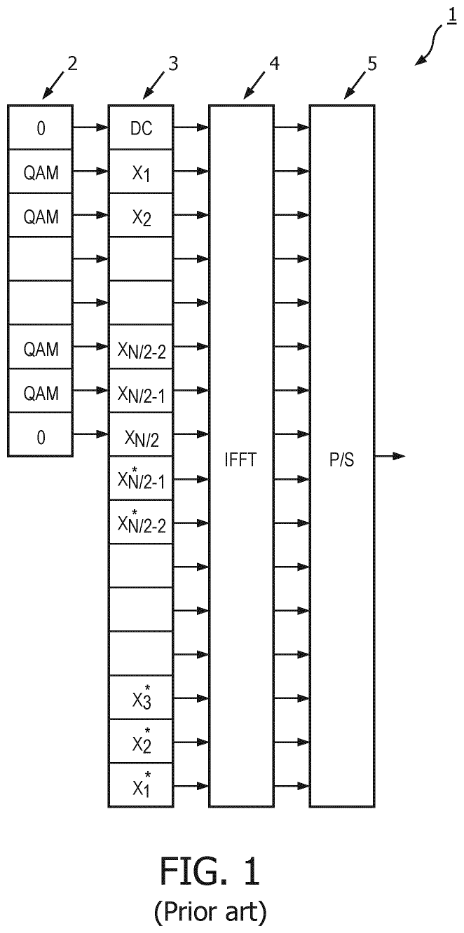

FIG. 1 shows a block diagram 1 of a FLIP Orthogonal Frequency Division Multiplexing, OFDM, modulator in accordance with the prior art.

Reference numeral 2 denote the QAM symbols that are to be transmitted. It is trusted that any person in the art is well aware of what QAM symbols are. As such, these types of symbols are not further explained in detail. Further details may however also be found in “Multi-Carrier Digital Communications: Theory and Applications of OFDM (Information Technology: Transmission, Processing and Storage)” 2^{nd} Edition, by Ahmad R. S. Bahai, et al, hereby incorporated by reference. It is further noted that the description here below refers to QAM symbols as being the data input symbols. However, other modulation types may exist as well, for example, QPSK or BQPSK or anything alike.

Reference numeral 3 denote that symbols to be transmitted on the respective OFDM subcarriers. Here, Xₙ is the QAM symbol that is to be transmitted in the n-th subcarrier. Note that X₀ which represents the DC component is indicated as “DC”, preferably the DC component is set to 0. The output of the inverse Fourier Transform, for example inverse Fast Fourier Transform or an inverse Discrete Fourier Transform, as indicated with reference numeral 4, at a k-th time instant is then given by:

$$x ( k ) = {\sum }_{n = 0}^{N - 1} {X}_{n} exp ( \frac{j 2 π k}{N} )$$

Here, N is the number of subcarriers, and thus also the size of the I-FFT, and j²=−1. The symbols Xₙ are that are to be transmitted over each OFDM subcarrier are independent, such that the time-domain signal x(k) that is generated by the IFFT operation is a complex-valued time domain signal. Typically, already known real-valued OFDM mechanisms assure that the output is a real-valued time domain signal by imposing the Hermitian symmetry property at the input, meaning:

Xₙ=X_{N-n}^{*}, wherein n=0, 1, 2, . . . , N/2

Here, the operator * denotes a complex conjugation. As mentioned above, this property implies that half of the OFDM subcarriers are sacrificed to generate a real time-domain signal at the output of the IFFT operation.

This is indicated with the bottom half of the column having reference numeral 3. The output of the IFFT block 4 is then serialized using a parallel to serial, P/S, generator block 5. The P/S generator block 5 may further be connected to other type of processing blocks for making the real-valued time domain signal adequate to be transmitted over an optical wireless communication link. For example, the signal is real-valued, but typically still bipolar. Which is solved by a copy and flip operation which is not explained in more detail with respect to FIG. 1.

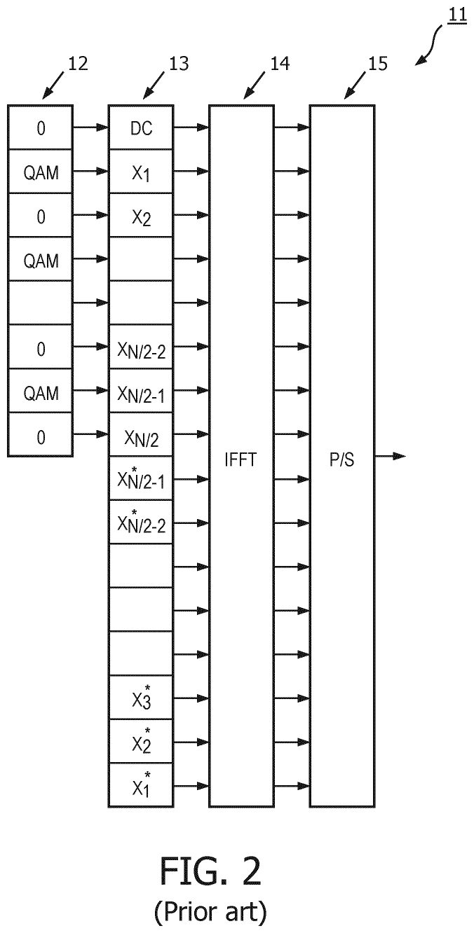

FIG. 2 shows a block diagram 11 of an ACO Orthogonal Frequency Division Multiplexing, OFDM, modulator in accordance with the prior art.

Here, reference numeral 12 indicates the QAM symbols, similar to the QAM symbols shown in FIG. 1. The difference is that the QAM symbols are interleaved with zeros, such that the QAM symbols are mapped onto the first half of only the odd subcarriers, as is shown with reference numeral 13. The even subcarriers are set to zero, i.e.

X₂ₙ₌₀, wherein n=0, 1, 2, . . . , N/2

Again, the Hermitian symmetry property is used, as explained before, to construct real-valued time domain signals at the output of the IFFT block generator 14, which are serialized using the P/S generator block 15.

The inventor has found that there is quite some similarity between a FLIP OFDM and an ACO OFDM signal, which is explained in more detail here below.

Both ACO and Flip OFDM systems convert N PAM data signals d₀ . . . d_{N-1} into 2N non-negative transmit samples, where mostly N is a power of 2. The process to reach these transmit signals is different, but the outcome has similarities. As a first step, in FLIP OFDM, N/2 complex valued QAM signals x₀, x_{N/2-1} are generated with xₙ=dₙ+j d_{N/2+n} where n=0, 1, . . . N/2−1. Other bit mappings may be used, but these are equivalent if we allow a renumbering of the symbols, without loss of generality. To create a real-valued output signal, it is common practice that these are extended into x_{N/2}, . . . , x_{N-1} to create an Hermitian-symmetric signal x_{N-k}=xₖ^{*}, so xₙ=d_{N-n}−j d_{N-N/2+n} for n>N/2.

Details of the modulation of d₀ and d_{N/2} on the DC sub carrier and the maximum frequency subcarrier are well known to any skilled person, both of which are only one-dimensional and can carry only a single PAM symbol.

In Flip-OFDM, an N-sized FFT is performed on vector x=x₁, . . . X_{N-1}

$${z}_{k} = {\sum }_{n = 1}^{N / 2 - 1} [ ( {d}_{n} + j {d}_{\frac{N}{2} + n} ) {e}^{\frac{2 π j n k}{N}} + ( {d}_{n} - j {d}_{\frac{N}{2} + n} ) {e}^{\frac{2 π j ( N - n ) k}{N}} ] + …$$

Here the “+. . . ” reflects specifically the two subcarriers 0 and N/2, which are omitted to avoid that these complicate the notation unnecessarily, while it does not give a deeper insight. Often, these two subcarriers are not participating in the data exchange, for instance because subcarrier 0 corresponds to a DC signal.

What we learn from this is that the upper half of the subcarriers, used to satisfy the Hermitian symmetry with the first half, create the complex conjugate of the lower half at the output signal. Adding it to the lower half of the frequencies, this creates a real-only signal.

FLIP OFDM uses an explicit copy-and-flip operation, where the set of time samples between N and 2N−1 are polarity-flipped versions of the symbols between 0 and N−1(Z_{N+k}=−Z_{N+k}), so

$${z}_{k} = \{ \begin{matrix}{\sum }_{n = 1}^{N / 2 - 1} ( {d}_{n} + j {d}_{\frac{N}{2} + n} ) {e}^{\frac{2 π j n k}{N}} + & for k ∈ ( 0 , N - 1 ) \\ ( {d}_{n} - j {d}_{\frac{N}{2} + n} ) {e}^{- \frac{2 π j n k}{N}} & \\ - {\sum }_{n = 1}^{N / 2 - 1} ( {d}_{n} + j {d}_{\frac{N}{2} + n} ) {e}^{\frac{2 π j n ( k - N )}{N}} + & \begin{matrix} \\ for k ∈ ( N , 2 N - 1 )\end{matrix} \\ ( {d}_{n} - j {d}_{\frac{N}{2} + n} ) {e}^{- \frac{2 π j n ( k - N )}{N}} & \end{matrix}$$

There is a crude, undesirable, swap of polarity after k=N In fact it is similar to the effects that occur in OFDM where two successive block carry different QAM signals, potentially in opposite quadrants. As spectral widening effects mostly are undesirable, windowing is commonly used in OFDM.

In fact, from

$${e}^{\frac{2 π j n N}{N}} = 1 ,$$

it can be seen that in OFDM a cyclic continuation of the OFDM block would yield continuous phases at all subcarriers, while FLIP-OFDM continues in an anti-cyclic manner, so it suffers from the spectral widening by inserting a polarity flip. This may be mitigated by a transition period between the two halves to allow separate windowing of the two halves. As we will show next, this can be avoided without jeopardizing performance.

For an apples-to-apples comparison with the same number of symbols, it is appropriate to compare FLIP OFDM using two FFT blocks each of size N, to ACO-OFDM using a size 2N FFT in (or FLIP OFDM having a N/2 sized FFT block with ACO OFD having a N sized FFT block). ACO-OFDM uses a double sized FFT and it maps the n-th and (N/2+n)-th data symbol to subcarrier 2n+1 of the 2N-FFT. Interestingly, we observe that this is equivalent to a (virtual) subcarrier (n+½) on a N-sized FTT. In fact, we see that for the 2N FFT

$${z}_{k} = {\sum }_{n = 1}^{N / 2 - 1} ( {d}_{n} + j {d}_{\frac{N}{2} + n} ) {e}^{\frac{2 π j ( 2 n + 1 ) k}{2 N}} + ( {d}_{n} - j {d}_{\frac{N}{2} + n} ) {e}^{\frac{2 π j ( 2 N - 2 n - 1 ) k}{2 N}}$$

If we insert

$${e}^{\frac{2 π j ( 2 n + 1 ) ( N + k )}{2 N}} = {( - 1 )}^{2 n + 1} {e}^{\frac{2 π j ( 2 n + 1 ) k}{2 N}} = - {e}^{\frac{2 π j ( 2 n + 1 ) k}{2 N}} ,$$

we observe that the property that the second half is a flipped copy of the first half, is satisfied automatically for ACO-OFDM, as we get

zₖ=−z_{N+k}

In other words, if we create an ACO-OFDM signal by firstly generating only N samples and the copy, shift over N and flip polarity, we arrive at the same ACO signal.

The ACO-OFDM signal can be rewritten as an N sized FFT as

$${z}_{k} = {\sum }_{n = 0}^{N / 2 - 1} ( {d}_{n} + j {d}_{\frac{N}{2} + n} ) {e}^{\frac{2 π j ( n + \frac{1}{2} ) k}{N}} + ( {d}_{n} - j {d}_{\frac{N}{2} + n} ) {e}^{- \frac{2 π j ( n + \frac{1}{2} ) k}{N}}$$

for k=0, 1, . . . N−1, and a cyclic extension for k=N,N+1, . . . 2N−1. As such, the difference between Flip OFDM and ACO-OFDM is just shift by half a subcarrier. ACO-OFDM adheres to

$${z}_{k} = {\sum }_{n = 0}^{N / 2 - 1} ( {d}_{n} + j {d}_{\frac{N}{2} + n} ) {e}^{\frac{2 π j n k}{N}} {e}^{\frac{2 π j k}{2 N}} + ( {d}_{n} - j {d}_{\frac{N}{2} + n} ) {e}^{- \frac{2 π jnk}{N}} {e}^{\frac{2 π j k}{2 N}}$$

Here the denominator in the complex exponential is N, not 2N, which allows implementation as an N sized FFT. Thus, we get ACO-OFDM by lifting the frequency of all subcarriers in Flip OFDM, by one half subcarrier spacing, which is the same as multiplying the output of samples after the TX FFT by exp

$$\pm \frac{π j k}{N} .$$

To facilitate an implementation, we also observe that, since (ab)*=a*b* and Re[2a]=a+a*, the samples zₖ to be transmitted may as well be written as

$${z}_{k} = Re [ 2 {\sum }_{n = 0}^{N / 2 - 1} ( {d}_{n} + j {d}_{\frac{N}{2} + n} ) {e}^{\frac{2 π j n k}{N}} {e}^{\frac{2 π j k}{2 N}}$$

In other words, we may not need to calculate the upper sub-carriers, we may just remove the imaginary part at the FFT output.

The present disclosure thus proposes to not apply Hermitian symmetry at the FFT input but to leave all higher subcarriers as zeros. At the output of the FFT, every output value may be phase rotated by exp

$$\frac{π j k}{N} ,$$

thus a linear ramp up to 180 degrees at k=N. Then the Real part is taken.

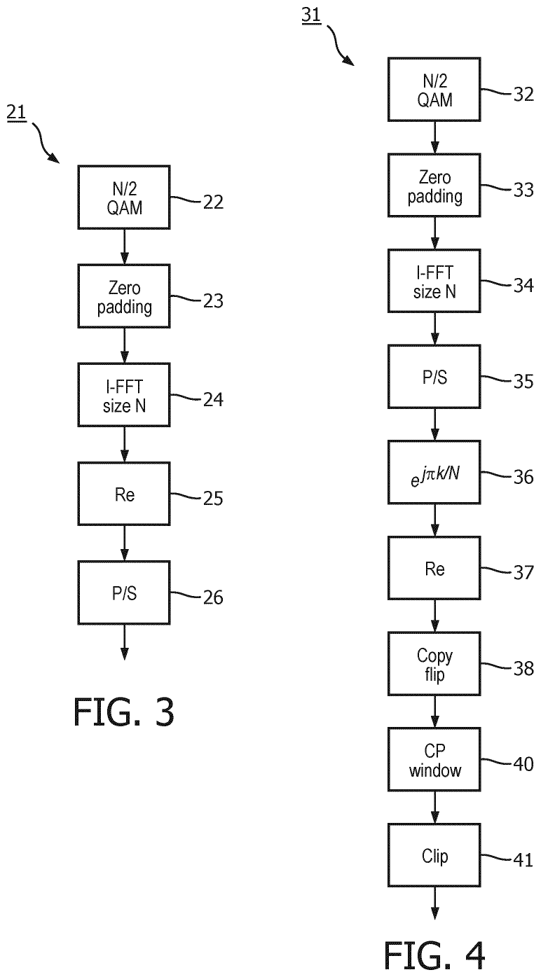

FIG. 3 shows a block diagram 21 of a modulator in accordance with the present disclosure.

Here, the block diagram 21 shows a modulator for generating an Orthogonal Frequency Division Multiplexing, OFDM, signal.

The modulator comprising a subcarrier generator block 22 arranged for generating N/2 consecutive subcarriers based on N/2 input data symbols. Here, N/2 QAM symbols are used as an input to create N/2 consecutive subcarriers. Consecutive means that the subcarriers are placed subsequently in frequency.

Next, a zero padding block 23 is provided which is arranged for consecutive padding said N/2 subcarriers with N/2 zeros, thereby obtaining N subcarriers.

The result of the above is that N/2 QAM symbols are used for generating N/2 consecutive subcarriers, which subcarriers are appended by N/2 zero's for obtaining in total N subcarriers.

The modulator further comprises an inverse Fourier Transform generator block 24 arranged for performing an N sized inverse Fourier Transform on said N subcarriers thereby providing N time domain signals at an output.

The present disclosure does not utilize the Hermitian symmetry property at the input for generating a real-valued time domain signal at the output of the IFFT. As such, the output of the IFFT, in accordance with the present disclosure, is a complex-valued time domain signal.

Further, the modulator is arranged to convert said N time domain signals into a time domain OFDM signal, and wherein said modulator further comprises:
a block 25 arranged for extracting a real-valued part from an inputted complex-valued time domain signal, which block is connected to said output of said inverse Fourier Transform generator block, such that said converted time domain OFDM signal is a real-valued time domain OFDM signal.

Finally, a Parallel to Serial, P/S, generator block 26 is provided for serializing the N time domain signals into a single real-valued time domain signal.

One of the aspects of the present disclosure is that the Hermitian symmetry of the OFDM input signal does not need to be created explicitly. It suffices to only feed the IFFT with complex QAM data for the first half of all subcarriers and leave the rest as zeros. At the output of the IFFT one can take the real part of the time domain signal.

The above described modulator may, for example, be suitable to be used as a FLIP OFDM modulator and a ACO OFDM modulator which will be explained in more detail with respect to FIG. 4.

It is noted that the modulator in accordance with the present disclosure may be utilized in a variety of field, for example in luminaires. The time domain signal that is construed by the modulator is suitable to be used in light communications. As such, a Light Emitting Diode, LED, based lighting device is especially suitable.

The LED based lighting device may have a primary function of providing environmental lighting to a room and may have a secondary function of wireless communications utilizing a modulator in accordance with the present disclosure. The modulator may be used to modulate the light output of the general illumination device provided that the bandwidth requirements can be satisfied in this manner. Optionally LEDs without phosphors may be used to enable higher speeds. Alternatively, the modulator may be used to modulate the light output of infrared emitters, such as light emitting diodes, thereby obviating the need to switch on the illumination light to enable communication.

In another example, the modulator in accordance with the present disclosure is implemented in a communication device, for example in a router, switch, smoke detector, sprinkler system, or anything alike. In such a case, the communication device does not need to provide any environmental lighting. The LED's may then be dedicatedly used for communication.

Alternatively, a laser, such as a vertical-cavity surface-emitting laser, VCSEL, can be used for intensity-modulated OFDM optical communication with a modulator as disclosed in the present disclosure.

FIG. 4 shows another block diagram 31 of a modulator in accordance with the present disclosure.

Here, the blocks as indicated with reference numerals 32, 33, 34, 35 and 37 are equivalent to the blocks in FIG. 3 as indicated with reference numerals 22, 23, 24, 26 and 37, respectively.

One of the differences of the modulator shown in FIG. 4 compared to the modulator shown in FIG. 3 is the introduction of a phase rotation block 36, which is arranged to phase rotate an inputted complex-valued time domain signal thereby providing a phase rotated complex-valued time domain signal.

The inventor has noted that ACO OFDM is very similar to FLIP OFDM, except that all subcarriers are shifted one frequency grid-point upwards. It appears that by shifting up, all subcarriers have a continuous phase halfway the frame, one can spectrally contain the signal better.

Following the above, it may be advantageous if said phase rotation block is arranged to phase rotate an inputted complex-valued time domain signal by:

φe^{jπαk/N}

wherein k indicates a k-th time instant of said OFDM signal, and a is α real-valued constant, preferably α=1, and wherein φ is a constant complex-valued phase, preferably φ=1 or φ=±j.

Whether or not to perform the phase rotating part of the present disclosure may thus be decided based on the actual intended transmission technique, for example FLIP OFDM or ACO OFDM.

Alternatively, to the phase rotating part after the IFFT, a subcarrier shifter block may be provided for shifting said N subcarriers upwards in frequency by one half subcarrier spacing before performing said N sized inverse Fourier Transform by said inverse Fourier Transform generator block.

So, in fact, for up-modulation with a frequency of, say α/2 we use, for the outputs:

$$RePart \times cos ( \frac{π α k}{N} ) + ImPart \times sin ( \frac{π α k}{N} )$$

The modulator 31 may further comprise a copy and flip operation 38 for making a real-valued time domain bipolar signal a real-valued time domain unipolar time domain signal, it may comprise a Cyclic Prefix, CP, generator block 40 arranged for generating a cyclic prefix to said real-valued time domain OFDM signal, and it may comprise a clipping generator 41 for clipping the time-domain signal.

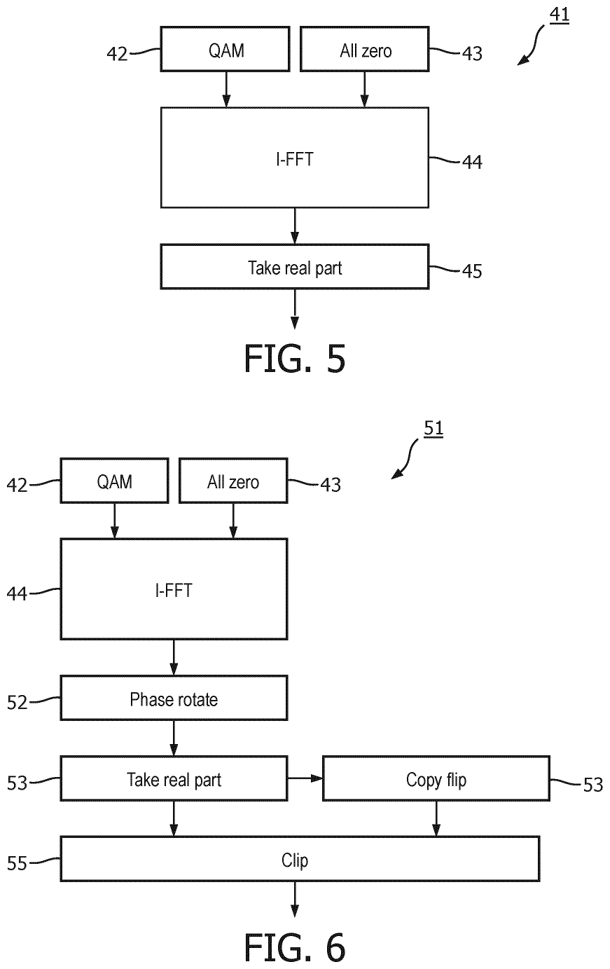

FIG. 5 shows a simplified block diagram of a modulator 41 in accordance with the present disclosure.

This figure is incorporated to visualize the basic concept of the present disclosure. As is shown, the QAM symbols 42 are extended with all zero's 43, and then an N-sized IFFT is performed 44. At the output of the IFFT 44, the real part is taken such that a real-valued time domain signal is obtained.

FIG. 6 shows an extended block diagram of a modulator 51 in accordance with the present disclosure.

The difference with the modulator shown in FIG. 5 is that at the output of the IFFT 44 a phase rotation 52 is performed for phase rotating the time domain signal. Only after performing the phase rotation, the real part 53 is taken and is copied and flipped 54 to assure that a unipolar signal is obtained. Finally, the time domain signal is clipped 55 and made ready for being transmitted. The thus modulated signal may be used as the control input for a high-bandwidth LED driver, that may be used to drive the LEDs of the Optical Wireless Communication device.

The light emitted by the Optical Wireless Communication device is subsequently received at a photo-sensitive receiver of a receiving device, e.g. a diode receiver. The diode receiver converts the impinging light into an electrical signal which can be converted by means of an ADC into a signal that can be processed by the demodulator.

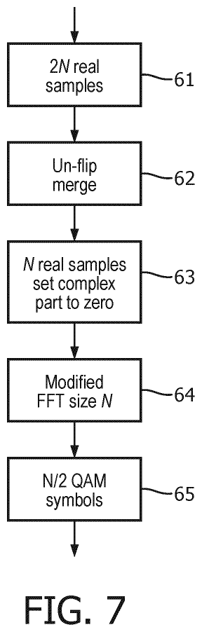

FIG. 7 shows an simplified block diagram of a demodulator, in accordance with the present disclosure.

It is noted that the detector may start with an operation that copies and adds the second half of the received N time samples ξₖ. Thus, this may constitute an unflip-and-merge operation to create the series of variables ξₖ−ξ_{N+k} for k=0, 1, . . . , N−1. Although here referred to as “unflip”, so as to exemplify that it corresponds to reverting to the original state, the “unflip” operation is effectively a polarity inversion. To simplify the explanation, noise and attenuation in the channel is omitted. Thus, for sake of explanation we write ξₖ=zₖ⁺ and ξ_{N+k}=z_{N+k}⁻, without channel, noise and amplification effects.

Inverting the previously mentioned operation, these are used as input to a N sized time-to-frequency transform, to create the output signal

$${ζ}_{n} = {\sum }_{k = 0}^{N - 1} ( {ξ}_{k} - {ξ}_{N + k} ) {e}^{- \frac{2 π j ( n + \frac{1}{2} ) k}{N}}$$

The above expression is a modified FFT, as it has the same structure as a regular FFT, but with complex exponentials that have slightly higher phase rotation

We observe that in ACO-OFDM, zₖ=zₖ⁺−Z_{N+k}⁻.

So, denoting m as the transmit subcarrier and n as the received subcarrier, after inserting the formula for the creation of an ACO-OFDM signal, we see that

$${ζ}_{n} = {\sum }_{k = 0}^{N - 1} ( {\sum }_{m = 0}^{N / 2 - 1} ( {d}_{m} - j {d}_{\frac{N}{2} + m} ) {e}^{\frac{2 π j ( m + \frac{1}{2} ) k}{N}} + ( {d}_{m} - j {d}_{\frac{N}{2} + m} ) {e}^{\frac{2 π j ( m + \frac{1}{2} ) k}{N}} ) {e}^{- \frac{2 π j ( n + \frac{1}{2} ) k}{N}}$$

Or, equivalently

$${ζ}_{n} = {\sum }_{k = 0}^{N - 1} ( {\sum }_{m = 0}^{N / 2 - 1} ( {d}_{m} + j {d}_{\frac{N}{2} + m} ) {e}^{\frac{2 π j ( m - n ) k}{N}} + ( {d}_{m} - j {d}_{\frac{N}{2} + m} ) {e}^{- \frac{2 π j ( m + n + 1 ) k}{N}} )$$

Where in fact the first terms reflect the lower subcarriers while the second term will create Hermitian symmetric outputs at the upper subcarriers.

Because of orthogonality of the subcarriers, the terms with n=m remain for the first sum of terms, and also the terms remain where m+n+1 forms an integer multiple of 2 for the second term.

For n<N/2, which is the relevant part of the FFT output, we perfectly recover the data, except for a constant multiplicative factor, because

$${ζ}_{n} = \{ \begin{matrix}N ( {d}_{n} + j {d}_{\frac{N}{2} + n} ) & for n < N / 2 \\ M ( {d}_{N - n - 1} - j {d}_{N - \frac{N}{2} n - 1} ) & for \frac{N}{2} < n < N\end{matrix}$$

Thus, it is shown above that the ACO-signal can be recovered using a transform of size N, while previously ACO OFDM detection was known as taking odd subcarriers in an FFT of size 2N.

The above is indicated in FIG. 7, with the subsequent reference numerals 61, 62, 63, 64, 65.

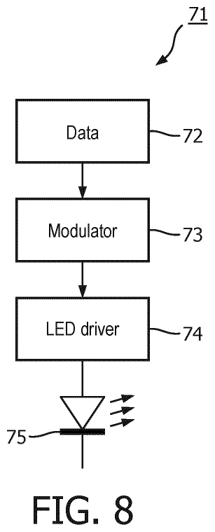

FIG. 8 shows a simplified block diagram 71 of a Light Fidelity, LiFi, transmitter using a modulator in accordance with the present disclosure.

FIG. 7 thus shows a LiFi transmitter comprising a modulator in accordance with any of the examples as provided above.

First, data 72 is generated, or construed, or provided to the modulator 73. The data may thus form the input data stream, and it may constitute the data the LiFi transmitter intends to transmit to a LiFi receiver. Such data may e.g. originate from a higher layer such as the Medium Access Control layer (MAC layer) of a larger communication stack where the data has been packaged in accordance with a communication protocol such as those from the IEEE and/or the ITU. The modulator 73 modulates the data 72 and generates a time domain OFDM signal. The time domain OFDM signal is used as an input to a Light Emitting Diode, LED, driver 74 for driving the one or more LED's 75. The LEDs in turn will emit the modulated light, which in embodiments may be illumination light, or alternatively infrared light.

It is noted that the modulator in accordance with the present disclosure may be advantageously used in optical wireless communication systems, such a LiFi systems. However, the presented modulator may be used in a variety of different communication systems, not excluding fiber communication or radio communication.

The claimed invention may be implemented on a general-purpose processor, a controller, a dedicated application specific instruction set processor, application specific integrated circuit and/or combinations thereof, which implementation is most desirable will, in part, be determined by the throughput requirements and/or the implementation platform. For example the zero padding and or extraction functions as claimed are more akin to functionality that may be implemented using a general purpose processor or controller, whereas fixed/low-level configurable signal processing operations, such as, but not limited to Fourier Transforms, generally benefit from implementations in custom hardware as these typically achieve better performance per Watt compared to more programmable platforms.

As discussed hereinabove, preferably the modulators and demodulators as disclosed herein are preferably used within Optical Wireless Communication devices in order to modulate and conversely demodulate the data to be transmitted.

In various implementations as envisaged, a processor or controller may be associated with one or more storage media (generically referred to herein as “memory,” e.g., volatile and/or non-volatile computer memory such as RAM, PROM, EPROM, and EEPROM, optical disks, hard disc drives, solid state drives, etc.).

In implementations, some of the storage media may be encoded with one or more programs that, when executed on one or more processors and/or controllers, perform at least some of the functions discussed herein. Various storage media may be fixed within a processor or controller, or in communication with the processor and/or controller. Alternatively, some media may be transportable, such that the one or more programs stored thereon can be loaded into a processor or controller so as to implement various aspects of the present invention discussed herein.

The terms “program” or “computer program” are used herein in a generic sense to refer to any type of computer code (e.g., software or microcode) that can be employed to program one or more processors or controllers.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope thereof.

1. A modulator for generating an Orthogonal Frequency Division Multiplexing, OFDM, signal, for use in data communication based on a data stream comprising input data symbols, said modulator comprising:
a subcarrier generator block arranged for generating N/2 consecutive subcarriers based on N/2 input data symbols,
a zero padding block arranged for consecutive padding said N/2 subcarriers with N/2 zeros, thereby obtaining N subcarriers;
an inverse Fourier Transform generator block arranged for performing an N sized inverse Fourier Transform on said N subcarriers thereby providing N time domain signals at an output;
wherein said modulator is arranged to convert said N time domain signals into a time domain OFDM signal, and wherein said modulator further comprises:
an extraction block arranged for extracting a real-valued part from an inputted complex-valued time domain signal, which block is connected to said output of said inverse Fourier Transform generator block, such that said converted time domain OFDM signal is a real-valued time domain OFDM signal.

2. The modulator in accordance with claim 1, wherein said modulator further comprises:
a Parallel to Serial, P/S, generator block for serializing said N time domain signals at said output into a time domain OFDM signal;
wherein said extraction block is connected to said P/S generator block such that said block takes a real-valued part of said serialized time domain OFDM signal.

3. The modulator in accordance with claim 1, wherein said modulator further comprises:
a phase rotation block, connected in between said inverse Fourier Transform generator block and said extraction block, which phase rotation block is arranged for phase rotating an inputted complex-valued time domain signal thereby providing a phase rotated complex-valued time domain signal.

4. The modulator in accordance with claim 3, wherein said phase rotation block is arranged to phase rotate an inputted complex-valued time domain signal by:
φe^{j παk/N}
wherein k indicates a k-th time instant of said OFDM signal, and α is a real-valued constant, preferably α=1, and wherein ϕ is a constant complex-valued phase, preferably ϕ=1 or ϕ=±j.

5. The modulator in accordance with claim 1, wherein said modulator further comprises:
a subcarrier shifter block arranged for shifting said N subcarriers upwards in frequency by one half subcarrier spacing before performing said N sized inverse Fourier Transform by said inverse Fourier Transform generator block.

6. The modulator in accordance with claim 1, wherein said modulator further comprises:
a copy-and-flip block arranged for copying and flipping said real-valued time domain OFDM signal and appending said copied and flipped real-valued time domain OFDM signal to said real-valued time domain signal thereby obtaining a full real-valued time domain OFDM signal.

7. The modulator in accordance with claim 6, wherein said modulator further comprises:
a Cyclic Prefix, CP, generator block arranged for generating a cyclic prefix to said full real-valued time domain OFDM signal.

8. A method for generating an Orthogonal Frequency Division Multiplexing, OFDM, signal for use in data communication based on a data stream comprising input data symbols, wherein said method comprises the steps of:
generating N/2 subcarriers based on N/2 input data symbols;
padding said N/2 subcarriers with N/2 zeros, thereby obtaining N subcarriers;
performing an N sized inverse Fourier Transform on said N subcarriers thereby providing N time domain signals at said output;
converting said N time domain signals into a time domain OFDM signal, and
extracting a real-valued part from an inputted complex-valued time domain signal, which block is connected to said output of said inverse Fourier Transform generator lock, such that said converted time domain OFDM signal is a real-valued time domain OFDM signal.

9. The method in accordance with claim 8, wherein said method further comprises the step of:
serializing said N time domain signals at said output into said time domain OFDM signal.

10. The method in accordance with claim 8, wherein said method further comprises the step of:
phase rotating an inputted complex-valued time domain signal thereby providing a phase rotated complex-valued time domain signal.

11. The method in accordance with claim 8, wherein said method comprises the step of phase rotating an inputted complex-valued time domain signal by:
φe^{j παk/N}
wherein k indicates a k-th time instant of said OFDM signal, and α is a real-valued constant, preferably α=1, and wherein ϕ is a constant complex-valued phase, preferably ϕ=1 or ϕ=±j.

12. The method in accordance with claim 8, wherein said method further comprises the step of:
shifting said N subcarriers upwards in frequency by one half subcarrier spacing before performing said N sized inverse Fourier Transform by said inverse Fourier Transform generator block.

13. The method in accordance with claim 8, wherein said method further comprises the steps of:
copying and flipping said real-valued time domain OFDM signal, and
appending said copied and flipped real-valued time domain OFDM signal to said real-valued time domain signal thereby obtaining a full real-valued time domain OFDM signal.

14. The method in accordance with claim 8, wherein said method further comprises the step of:
generating a cyclic prefix to said real-valued time domain OFDM signal.

15. Computer program product comprising a non-transitory computer readable medium having instructions stored thereon which, when executed by a modulator, cause said modulator to implement a method in accordance with claim 8.

16. A real-valued time domain OFDM signal obtained by a method in accordance with claim 8.
